(19) United States
(12) Patent Application Publication
(10) Pub. No.: US 2009/0070886 A1
(43) Pub. Date: Mar. 12, 2009

(54) METHOD FOR SECURELY DELIVERING AUDIOVISUAL SEQUENCES, DECODER AND SYSTEM THEREFOR

(75) Inventors: Daniel Lecomte, Paris (FR); Octavian Folea, Le Kremlin-Bicetre (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Medialive, Montrouge (FR)

(21) Appl. No.: 12/282,371

(22) PCT Filed: Mar. 1, 2007
(86) PCT No.: PCT/FR07/50860

§ 371 Date: Nov. 6, 2008

(30) Foreign Application Priority Data
Mar. 10, 2006 (FR) 0650814

(51) Int. Cl. H04L 9/32

(52) U.S. Cl. 726/27

(57) ABSTRACT

A method for delivering a nominal audiovisual stream including nominal coefficients to a receiving site including a secure gateway includes modifying, in the nominal audiovisual stream, at least one nominal coefficient among the nominal coefficients to generate a main digital stream; generating complementary information so that the nominal audiovisual stream is implemented from the complementary information and main digital stream at the receiving site; performing cryptographic operations on the secure gateway with the complementary information; and causing the gateway to transmit the complementary information to an audiovisual processing peripheral to enable the nominal audiovisual stream to be implemented at the audiovisual processing peripheral.

### RELATED APPLICATIONS

This is a §371 of International Application No. PCT/FR2007/050860, with an international filing date of Mar. 1, 2007 (WO 2007/104876 A1, published Sep. 20, 2007), which is based on French Patent Application No. 06/50814, filed Mar. 10, 2006.

### TECHNICAL FIELD

This disclosure relates to the field of the secure delivery of audiovisual sequences.

### BACKGROUND

One technique for protecting an audiovisual sequence consists of modifying the digital audiovisual stream upon the broadcasting thereof so that it is compatible with the standard formats and can be recognized by a drive equipment, but cannot be seen or heard, i.e., implemented as such, in a satisfactory manner for a recipient. Complementary information is transmitted on a separate channel. The combination of the main digital stream and such complementary information makes it possible to implement the initial audiovisual sequence only.

The user has a decoder receiving the main digital stream, also called the modified audiovisual stream, as well as the complementary information. Such decoder must have mass storage means to provide a buffer between the incoming stream, which can be limited by the rate of the link between the decoder and the network, and the audiovisual processor which provides for the reconfiguration. In addition, the mass storage must be protected against the possible attempts to recover the initial audiovisual sequence. Thus, it concerns relatively expensive equipment, which limits the possible broadcasting of sequences using such technique.

WO 2004/066627 provides for the implementation of a simplified decoder, while guaranteeing a high security level against piracy, using a method for delivering video sequences consisting in broadcasting a main digital stream and complementary information required for visualizing the video sequence, and reconstructing, on the receiving site, the video stream displayable on equipment provided with a screen, characterized in that the receiving site includes a personal computer comprising a high data rate connection and mass storage means, and a video processing peripheral provided with means for communicating with the personal computer and for transmitting the displayable stream to a display device, the main digital stream being received by the personal computer, the software application for reconstructing the display stream being carried out in the video processing peripheral and not in the personal computer.

However, such a method has the drawback of providing a security level which is limited with respect to the attacks aimed at illegally retrieving the video sequence. Such limitation is brought by the personal computer which is in charge of identifying and authenticating the user as well as transmitting the complementary information to the video processing peripheral.

The hardware architecture of the personal computer is open, which allows all the users a complete and non-restrictive access to each of its system components: the random access memory, the processor, the storage means or the input/output interfaces. Thus, a hacker has all means available for intercepting the plain complementary information at the input/output or random access memory interfaces upon the processing thereof by the personal computer.

It could therefore be helpful to improve the security of the method for delivering video sequences.

### SUMMARY

We provide a method for delivering a nominal audiovisual stream including nominal coefficients to a receiving site including a secure gateway including modifying, in the nominal audiovisual stream, at least one nominal coefficient among the nominal coefficients to generate a main digital stream; generating complementary information so that the nominal audiovisual stream is implemented from the complementary information and main digital stream at the receiving site; performing cryptographic operations with the secure gateway on the complementary information; and causing the gateway to transmit the complementary information to an audiovisual processing peripheral to enable the nominal audiovisual stream to be implemented at the audiovisual processing peripheral.

We also provide a method for delivering the audiovisual sequences according to the method for delivering the nominal audiovisual stream, wherein the complementary information is received and transmitted to the audiovisual processing peripheral through the secure gateway.

We further provide a secure gateway that implements the method for delivering the nominal audiovisual stream, including receiving means arranged to receive the complementary information and cryptographic means arranged to carry out cryptographic operations on the complementary information.

We still further provide a system including a decoder including a disk drive, whereon main digital streams are recorded and wherein the decoder includes means for communicating with the secure gateway to receive the complementary information.

### BRIEF DESCRIPTION OF THE DRAWINGS

Our methods and systems will be better understood upon reading the following description while referring to the appended drawings corresponding to non-limitative examples, wherein:

FIG. 1 shows the principle diagram of a decoder; and

FIG. 2 shows an alternative solution of a decoder.

### DETAILED DESCRIPTION

We provide methods for delivering a nominal audiovisual stream to a receiving site including a secure gateway, the nominal audiovisual stream comprising nominal coefficients, the method comprising:
modifying, in the nominal audiovisual stream, at least a nominal coefficient among the nominal coefficients to generate a main digital stream;
generating complementary information, so that the nominal audiovisual stream is capable of being implemented from the complementary information and the main digital stream at the receiving site;
causing the secure gateway to carry out cryptographic operations on the complementary information; and
causing the gateway to transmit the complementary information to the audiovisual processing peripheral to allow the implementation of the nominal audiovisual stream at the audiovisual processing peripheral.

Thanks to the utilization of the secure gateway, we make it possible to control secure transmission of the complementary information towards the video processing peripheral through a secure gateway and not through a personal computer as in the above-mentioned document.

It is known that a secure gateway is a device including:
a closed hardware architecture which prevents the non-authorized access to at least one software or hardware component by hardware means; and
a secure core which regulates the authorized access to at least one software or hardware component through various security levels, which vary from a total access to a total override.

Optionally, such a secure gateway can also be such that the component includes information storage means enabling the unique identification of the secure gateway, the information being stored upon the creation of the component and it being impossible to modify it subsequently.

The personal computer, such as used in WO 2004/066627, contains no component meeting the criteria defining the secure gateway since:
the hardware architecture of the personal computer is open, which enables a total and non-restrictive access to all components of the personal computer (the random access memory, the processor, the storage means, the input/output interfaces and so on);
the personal computer provides the user with means (keyboard, screen, printing machine and so on) for visualizing and modifying data which is processed or conveyed by the components anytime during the working condition;
the open architecture of the computer makes it easier for the user to retrieve each component and to use it with another personal computer or any other type of processing device; and
the personal computer contains no component capable of preventing the modification of information capable of identifying, in a unique way, the personal computer.

A non-limitative example of such device meeting the criteria of a secure gateway is the chip card. It contains a protected core which protects the access to its components: the memories of the ROM (Read Only Memory), PROM (Programmable Read Only Memory) and EEPROM (Electrically Erasable Programmable Read Only Memory) types. The ROM memory is written by the manufacturer and it cannot be modified afterwards. The PROM memory contains information enabling the unique identification of the chip card. Access to the EEPROM memory is authorized according to the security levels. The chip card is, for example, in the ISO 7816 standard format, and includes, in a way known per se, a closed hardware architecture which prevents non-authorized access to the software or hardware components thereof by hardware materials such as the miniaturization and the exploitation of magnetic fields. Thanks to such features, non-authorized access to the components of a chip card requires devices and extremely sophisticated competences and extremely expensive characteristics which are not available to the public.

The chip cards can be used for various operations in heterogeneous devices: mobile telephones, bank cards, access cards and so on. With respect to personal computers, mobile telephones using a chip card (the SIM card or Subscriber Identity Module card) are more widely used on the market and provide the user with a better usability.

The state of the art knows an always wider extension of network equipment which contains secure components enabling, on the one hand, to protect the stream of data which circulate on the network and, on the other hand, the access to configuration parameters of the equipment. Considering such characteristics, those skilled in the art consider that equipment as protected gateways.

It is quite surprising that the protection of the audiovisual stream can be carried out by a chip card, more particularly because of the low storage capacities and a limited calculation capacity of such a chip card. However, we found that such a chip card can fulfil such function of protecting the audiovisual stream by protecting the complementary information separately from the nominal audiovisual stream, and more particularly by carrying out cryptographic operations thereon.

The complementary information depends on the type of the audiovisual contents to be transmitted. Such complementary information may, for example, be generated as in WO 2004/032418 for audio sequence, or as in WO 2003/063445 for an audiovisual sequence in the MPEG format. The complementary information may also include customized information depending on the recipient such as in WO 2004/073311, or visible marking information such as in WO 2004/062281 or invisible marking information such as in FR 06/55315 (now FR 2 909 507 A1). As in these applications, the main digital stream is preferably generated by retrieving at least one coefficient from the nominal stream and by inserting such coefficient or coefficients into the complementary information.

In any case, processing the complementary information and the main digital stream by a synthesis module makes it possible to implement the nominal stream, for example, by reconstructing such stream in a similar way, or by adding visible or invisible data whereas the main digital stream cannot be implemented at the receiving equipment in the absence of the complementary information.

As the complementary information can be of a reduced size, and typically 1% of the size of the nominal audiovisual stream, the chip card protection is possible by carrying out cryptographic operations on the complementary information and not on the whole contents of the nominal audiovisual stream.

We thus provide for utilization of the chip card to protect the delivery of an audiovisual stream, more particularly by carrying out cryptographic operations on the complementary information.

It should be noted that in WO 2004/066627, the personal computer includes a card drive, and is able to receive a chip card. However, in such document, the chip card carries out no cryptographic function but only authentication and storage functions. In WO 2004/066627, only protective cryptographic functions are carried out by the personal computer, with the drawbacks mentioned above.

Our secure gateway may further carry out the authentication and storage functions as did the computer associated with the chip card drive in WO 2004/066627.

Utilization of the secure gateway makes it possible to improve the security of the delivering method and thus makes it possible to solve the above-mentioned problem.

In addition, the main digital stream is transmitted by the server through a digital network, the audiovisual processing peripheral 2 including a high data rate line for receiving the main digital stream.

The main digital stream may be transmitted by the server through a hardware support, the audiovisual processing peripheral 2 including a drive to operate the hardware support and play the main digital stream.

The main digital stream may be transmitted by the secure gateway or by a personal computer through wire connections, for example the Ethernet, FIREWIRE or USB-2 types, or through one of the wireless connections, for example, of the Bluetooth, WiFi or AirPort types, the audiovisual processing peripheral 2 including one interface or several interfaces capable of receiving the main digital stream.

According to one alternative, the main digital stream is directly received by the audiovisual processing peripheral.

According to another alternative, the main digital stream is received by a personal computer located in the vicinity of the audiovisual processing peripheral, the main digital stream being transmitted by a local network connection to the audiovisual processing peripheral.

According to yet another alternative, the main digital stream is stored on a storage peripheral which can be read by the audiovisual processing peripheral. According to still another alternative, the main digital stream is received by the secure gateway prior to being transmitted to the audiovisual processing peripheral. In any case, the complementary information is received by the secure gateway prior to being transmitted to the audiovisual processing peripheral. In another alternative, the main digital stream complies with the original audiovisual stream standard.

Digital rights on the implementation of the main digital stream may be transmitted by a server and are acquired by the secure gateway.

In one example, the secure gateway includes a module for protecting the reception of the complementary information transmitted by the server. In addition, it includes a module for forwarding the complementary information between the secure gateway and the audiovisual processing peripheral of the decoder.

The secure gateway may include a manager for the digital rights which condition the implementation of the main digital stream by the audiovisual processing peripheral 2. An authentication may be carried out between the audiovisual server and the secure gateway upon the request for the complementary information.

An authentication requested by the protocol of transmission of the complementary information is carried out between the secure gateway and the audiovisual processing peripheral of the decoder. Advantageously, one authentication component is the checking of the digital rights previously acquired.

We also provide a decoder including an input for receiving a digital stream, an audiovisual processing circuit for reconfiguring an implementable stream from the digital stream and complementary information, and an output delivering a displayable audiovisual signal on the display and/or listening device.

Preferably, the decoder includes means for communicating with the network for receiving the complementary information.

According to an alternative, it includes means for communicating with the secure gateway for receiving the main digital stream.

The decoder may thus include wireless means for communicating with the personal computer, for receiving the digital stream.

We also disclose a system for implementing the method comprising a decoder, a secure gateway, the device including a disk drive for disks which the main digital streams are recorded on and the decoder including means for communicating with the device, for receiving the main digital stream.

For the reception and exploitation of the broadcast audiovisual sequences, each user shall have two complementary pieces of equipment available:
a secure gateway 1, and
a decoder 2.

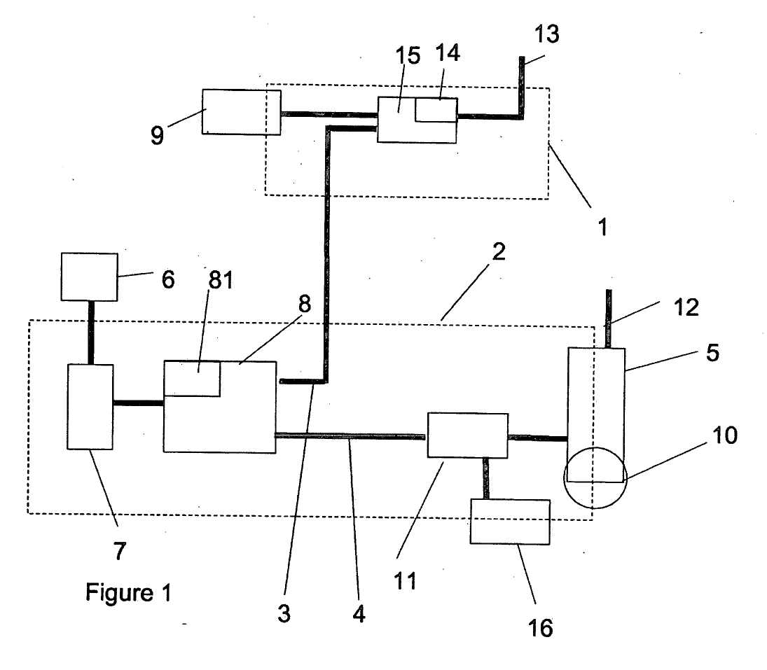

In FIG. 1, the decoder 2 includes an output for connecting at least one display and/or listening device, for example, a monitor, a video system, a device of the television set screen type, an audio track drive, a PDA or any other device such, for example, an audiovisual system 6.

The decoder 2 mainly includes, on the one hand, a processing unit adapted for processing, and in particular decoding and descrambling any digital audiovisual stream, for example, of the MPEG type according to a pre-loaded decoding and descrambling software program, so as to display it in real time and, on the other hand, at least an audiovisual interface 7.

The decoder is also connected to a gateway 1 through one or several wire connection(s), for example, of the Ethernet, FIREWIRE or USB-2 types, or through a wireless connection, for example, of the Bluetooth, WiFi or AirPort types. The connection 3 forwards the complementary information, and the connection 4 forwards the audiovisual stream modified by the server to make it unworkable as is.

The connection 3 may be the same as the connection 4.

When the user of the decoder 2 really wants to implement the audiovisual program on its audiovisual device 6, the user makes a request with the synthesizer 8 using its remote control as the user would do with a VCR or a DVD drive showing a menu on the user's television set 6. The decoder dialogs with the secure gateway 1 for starting the transmission of the modified audiovisual stream. The synthesizer 8 starts analyzing the modified digital stream from the hard disk 10 of the decoder via the drive buffer 11 of the decoder. The decoder 2 then establishes a connection with the audiovisual server via the telecommunication network 12 which is here a connection with the Internet of the DSL type or a connection with a local network.

The remote control may be incorporated in the secure gateway 1.

The hard disk 10 of the decoder 2 can be used as a buffer memory to temporarily store at least a part of the program or the audiovisual sequence to be implemented, in case of a delayed visualization or a limitation in the passband of the transmission network 12. The implementation may be delayed or postponed upon the request by the user or the audiovisual server.

The disk drive 10 may be located outside the decoder 2 and connected thereto for a wire connection of the USB-2, FIREWIRE types or a decoder 2 owner connection.

As shown in FIG. 1, a connexion interface 5 of the decoder 2 is connected to a network for transmitting and broadcasting in a large bandwidth 12 such as a modem, a satellite modem, a wired modem, an optical fiber line interface or a radio interface or an infrared interface for the wireless communication.

The contents of audiovisual programs such as films will be transmitted on such conventional connection for an audiovisual broadcasting. However, to prevent making of pirated copies, prior to transmitting the audiovisual contents from the server, a small part of the audiovisual contents is kept in the portal or the audiovisual server.

When an audiovisual program is implemented in real time, such small part of the audiovisual contents, also called complementary information, which is kept in the server, will also be transmitted to the interface module 15 via the telecommunication network 13 which can be the same network as the one used for the transmission and the wide bandwidth diffusion broadcasting 12.

The module 15 may comprise a forwarding function 14 making it possible to transfer data between the audiovisual server and the decoder 2 so that no specific processing of the data is carried out by the secure gateway 1.

As the successive images of an audiovisual sequence include a large number of similar visual elements (as in a movie, a image looks like the previous one), the MPEG format records only the elements which are different from the original image. For example, without such example being limitative, a full reference image is modified while preserving the DC coefficients of the modifications brought in the portal and, for the successive images which depend on such reference image I, it is not necessary to make modifications since they will make the implemented stream diverge because of the interferences brought in the reference images I. The MPEG compression then can be started first to deconstruct the image into various square matrixes including several points or pixels, which each have their own color values. A calculation makes it possible to obtain an average value for each matrix within which each point is now buried. Such processing generates a pixellization and the generation of uniform patches, where only shades existed. The second step of the MPEG compression keeps only the modified elements from one image to another.

In the case of an audiovisual program of the MPEG type, all the characteristics of the images I from the audiovisual server are not transmitted to the module 5. More particularly, the characteristics may be the correlation coefficients DC contained in the images I.

Some coefficients DC of such images I are kept in the audiovisual server. On the contrary, instead of the coefficients DC of such images I which have not been transmitted, the server will add false coefficients DC having the same nature as the deleted coefficients. DC kept in the portal, so that the standard MPEG drive of the module 8 is not perturbed by such modifications which it will ignore and it will reconfigure, as an output, an MPEG output stream which will not be correct from the visual point of view for a human being but will be correct from the MPEG format point of view, which means that the main digital stream containing the false coefficients DC will comply with the MPEG standard. Generally speaking, the modifications on the coefficients are made so that the modified main digital stream is strictly complying with the standard of the original digital audiovisual stream.

The MPEG drive 8 of the decoder 2 is a standard MPEG drive and is in no way modified or affected by the modifications brought to the images I.

As shown in FIG. 1, the connection interface of the secure gateway 1 is connected to an extended telecommunication network, directly or through a local network using an access network and is composed, for example, of a subscriber line interface (analog or digital telephone network, DSL, BLR, GSM, GPRS, UMTS and so on).

Thus, the audiovisual programs are conventionally broadcast in a multi-broadcast mode via the wide band transmission network 12 of the hertzian, cable, satellite, hertzian digital, DSL types and so on. Each audiovisual program so broadcast can be ciphered or not, and the MPEG type streams include modifications as regards some images I as described above. Depending on the parameters selected by the user or the information transmitted by the broadcasting server, some audiovisual programs thus modified and not complete are recorded on the hard disk of the computer 1.

When the user wishes to implement, an audiovisual program thus recording on the hard disk 10 of decoder 2, the user gets connected to the portal via the connection of the local network or direct access type and through the telecommunication network which is also connected to the audiovisual server.

Along the implementation of the audiovisual program, the connections remain established and make it possible for the secure gateway 1 to receive, through the connection 13, the functions and the parameters acquired for reordering the modified coefficients DC of the images I. The main digital stream coming from the hard disk of the decoder 2 and the complementary information coming from the audiovisual server via the connection 13 are transmitted to the decoder 2 via the connections 4 and 3, respectively. The combination of the main digital stream and such complementary information makes it possible to implement the initial audiovisual sequence. The modified coefficients DC of the images I thus transmitted are never recorded in the hard disk of decoder 2 since the recomposed images I are directly displayed on the visualization screen 6 via the processing carried out by the decoder 2 after having been processed by the drive 8 from the read only memory 81. Once processed and visualized, the modified coefficients DC and/or the missing ones of images I which have just been transmitted by the audiovisual server will be deleted from the local read only memory 81 of the decoder 2.

Each time a user wants to look at a program recorded in the hard disk 10 of the decoder 2, the user will automatically get connected to the secure gateway 1. According to a particular example, the secure gateway 1 includes a chip card drive 9 which enables the portal to authentify the user owing the secure gateway 1. The authentication is carried out between the audiovisual server and the secure gateway upon the request for the complementary information. Upon such authentication step, the information relating to the authentication goes through the secure gateway 1.

For a given MPEG audiovisual contents, the chip card may contain such complementary information.

Implementation of a given MPEG audiovisual contents may be conditioned by digital rights. The digital rights are the information mentioning the conditions in which the contents may be implemented: (a) the number of implementations of the contents, (b) the validation date which the contents may be implemented on, (c) the date of expiry from which the contents can no longer be implemented, (d) the domain for which the implementation is allowed, (e) the type of the decoder 2 which enables the implementation, (f) and so on.

According to one alternative, the digital rights are received by the secure gateway 1 through the connection 13.

According to another alternative, the digital rights are received by the secure gateway 1 via the chip card drive 9.

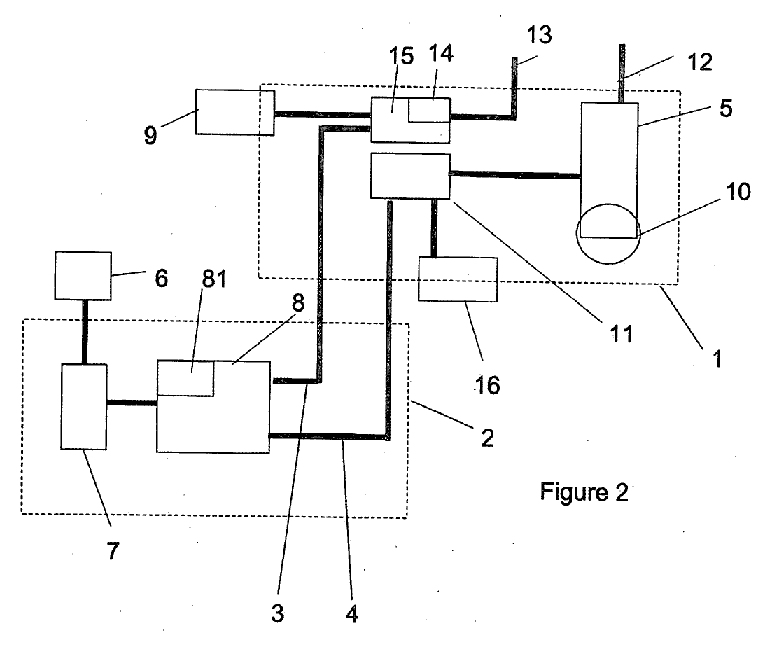

FIG. 2 shows an alternative example wherein the secure gateway 1 is in charge of the reception of the main digital stream sent by the audiovisual server and the transmission of the main stream towards the decoder 2 on the network 13.

The first authentication step is carried out between the audiovisual server and the secure gateway 2 upon the request for the complementary information.

The second authentication step is carried out between the secure gateway 1 and the decoder 2 upon the request for the implementation of the audiovisual sequences.

In FIGS. 1 and 2, the decoder 2, respectively the secure gateway 1, include a disk drive 16, for example a CD or a DVD drive to directly play the main digital streams recorded on the disks. The main digital streams are recorded previously on the disks.

The digital rights may be received by the secure gateway 1 via the transmission network 12.

1-17. (canceled)

18. A method for delivering a nominal audiovisual stream comprising nominal coefficients to a receiving site including a secure gateway comprising:
modifying, in the nominal audiovisual stream, at least one nominal coefficient among the nominal coefficients to generate a main digital stream;
generating complementary information so that the nominal audiovisual stream is implemented from the complementary information and main digital stream at the receiving site;
performing cryptographic operations on the secure gateway with the complementary information; and
causing the gateway to transmit the complementary information to an audiovisual processing peripheral to enable the nominal audiovisual stream to be implemented at the audiovisual processing peripheral.

19. The method according to claim 18, wherein the secure gateway has a closed hardware architecture.

20. The method according to claim 18, wherein the secure gateway comprises at least a hardware component, the access to which is regulated by at least one security level.

21. The method according to claim 18, wherein the secure gateway has a closed hardware architecture which inhibits the non-authorized access to at least one software or hardware component by hardware means, and
a secure core which regulates authorized access to at least one software or hardware component through various security levels, which vary between a total access to a total override.

22. The method according to claim 18, wherein the secure gateway includes means for storing information enabling unique identification of the secure gateway, the information being saved upon creation of the component and it being impossible to modify it subsequently.

23. The method according to claim 18, wherein the secure gateway is a chip card.

24. A method for delivering audiovisual sequences according to claim 18, wherein the complementary information is received and transmitted to the audiovisual processing peripheral through the secure gateway.

25. The method according to claim 24, wherein the digital stream is received by the secure gateway prior to being transmitted to the audiovisual processing peripheral.

26. The method according to claim 24, wherein the main digital stream complies with the standard of the original audiovisual stream.

27. The method according to claim 24, wherein a first authentication is carried out between the audiovisual server and the secure gateway upon a request for complementary information.

28. The method according to claim 24, wherein a second authentication is carried out between the secure gateway and the audiovisual processing peripheral of the decoder upon the request for implementation.

29. A secure gateway that implements the method according to claim 18, comprising receiving means arranged to receive the complementary information and cryptographic means arranged to carry out cryptographic operations on the complementary information.

30. The secure gateway according to claim 29, wherein the secure gateway is a chip card.

31. The secure gateway according to claim 29, wherein the secure gateway comprises at least one hardware component, the access to which is regulated by at least one security level.

32. The secure gateway according to claim 29, comprising a component including means for storing information enabling unique identification of the secure gateway, the information being saved upon creation of the component and it being impossible to modify it subsequently.

33. The secure gateway according to claim 29, further comprising means for management of rights on the contents.

34. A system comprising a decoder including a disk drive, whereon main digital streams are recorded and wherein the decoder includes means for communicating with the secure gateway according to claim 29, to receive the complementary information.
